(19) United States
(12) Patent Application Publication
(10) Pub. No.: US 2010/0005557 A1
(43) Pub. Date: Jan. 14, 2010

(54) FLUID-TIGHT SLIDE FASTENER

(75) Inventors: Livio Cossutti, Mendrisio (CH); Marc Butz, Agnuzzo (CH)

Correspondence Address: AKERMAN SENTERFITT, P.O. BOX 3188, WEST PALM BEACH, FL, 33402-3188, US

(73) Assignee: Riri Group, S.A., Mendrisio (CH)

(21) Appl. No.: 12/233,114

(22) Filed: Sep. 18, 2008

(30) Foreign Application Priority Data
Oct. 4, 2007 (EP) 07019496.4

(51) Int. Cl. B63C 11/04; A44B 19/32; B29D 5/00; E04H 15/00

(52) U.S. Cl. 2/2.17; 24/389; 29/408; 135/87

(57) ABSTRACT

A fluid-tight slide fastener (10) comprising tapes (12) with an inner textile layer (14) and a fluid barrier layer (16), teeth elements (21) and a slider (22), wherein said textile layer (14) is made with a spun yarn of cut fibers. Preferred materials are also disclosed for the textile layer, the fluid barrier layer and the teeth, including PE for textile layer, TPE-E or TPE-U for the fluid-barrier layer and PBT, ABS, polyamide (PA) and their blends or copolymers for the teeth. A process for making slide fasteners is also disclosed, wherein strips of a spun yarn textile material are coated by extrusion or lamination of a melted fluid-barrier material.

### FIELD OF APPLICATION

The present invention refers, in its broader aspect, to a fluid-tight slide fastener. The present invention also refers to a process for manufacturing a fluid-tight slide fastener.

The term “fluid-tight” refers to resistance to passage of a liquid and/or gas, e.g. water and/or air, even when the slide fastener is subjected to remarkable pressure difference between the interior and the exterior, for example up to about 2 bars.

### PRIOR ART

Fluid-tight slide fasteners are required for many applications, such as provision of sports and outdoor activity items, diving or sailing suits, camping tents and the like. Said fasteners are often also required to be tenacious and easily pliable.

A slide fastener, in general terms, comprises a pair of tapes bearing respective rows of teeth, top and bottom stops, and a slider for engaging and disengaging the teeth. A known structure for a fluid-tight slide fastener comprises multi-layered tapes, with an inner reinforcing layer of a textile material enveloped in an outer fluid-barrier layer, in such a way that no part of the inner textile material is exposed to the surface, and to seal the aligned teeth on the outer fluid barrier material of the respective tapes so that a fluid-tight bonding is formed between the teeth and the fluid-barrier material.

More in particular, according to the prior art, use of a combination of a textile material for the inner layer of the tapes, a thermoplastic elastomer material (TPE) for the outer fluid-barrier layer and a thermoplastic material for the teeth is known.

These materials have proven to give impermeability and flexibility of the tapes, as well as stability to light, resistance to sea water, and also easiness of sealing, gluing and stitching. Furthermore, such materials can be efficiently worked in extrusion processes by which the layered structure of the tapes is formed and in injection overmolding processes by which the teeth are sealed to the tapes.

These known slide fasteners prove to be effectively fluid-tight at the teeth—outer barrier layer interface, but are often unsatisfactory in terms of mechanical properties and suffer the drawback of so-called delamination, i.e. separation of the layers form one another, especially due to intensive use and/or frequent washing.

Delamination is mainly due to a non-satisfactory adhesion between the materials constituting the inner and the outer layers of the tapes, causes the tapes to weaken and the inner textile material to become exposed to the surface, thus compromising the fluid-tight performance.

### SUMMARY OF THE INVENTION

The technical problem underlying the present invention is that of improve the performance and reliability of fluid-tight slide fastener with layered tapes, with particular regard to the ability to withstand severe conditions of use and/or long-term use without mechanical damage such as separation between layers (delamination).

This problem is solved, according to the present invention, by a fluid-tight slide fastener with tapes comprising an inner textile layer made of a spun yarn of cut fibers, according to claim 1.

Preferred embodiments and materials are described in the dependent claims.

The textile material is chosen so as to be suitable for, and compatible with, the requirements of the end products onto which the slide fastener is to be applied.

According to an aspect of the invention, a fluid-barrier layer enveloping the inner textile layer of the tapes is made with a thermoplastic elastomer material (TPE). Said material, which is per se known, has a hard phase and a soft phase which confer thermoplastic properties and elastomer properties (flexibility) respectively and may include block copolymers as well as blends comprising a thermoplastic material and an elastomer material.

According to preferred embodiments, said TPE is a TPE-E or TPE-U, that is a thermoplastic elastomer polyurethane (TPE-U) or a thermoplastic elastomer polyester (TPE-E).

Preferably, said TPE-E is a polyether-ester block copolymer and said TPE-U is a block copolymer obtained from an ether and/or an ester and a isocyanate.

According to another aspect of the invention, teeth of the slide fastener are made of a thermoplastic material consisting of a blend including PBT and polycarbonate (PC). Preferably, the PBT/PC weight ratio in said blend ranges between 70/30 and 30/70.

According to preferred embodiments, the teeth are made of a blend including acrylonitrile butadiene styrene (ABS) and a polyamide (PA). Preferably, the ABS/PA weight ratio in said blend ranges between 70/30 and 30/70.

According to another aspect of the invention, the materials of the fluid barrier layer and teeth may include suitable additives such as, for instance fillers, pigments, binders and/or compatibilizers, the latter being incorporated to improve the physical and chemical affinity between said materials and/or between the materials used for the layered structure of the tape.

According to a more preferred aspect of the invention, a fluid barrier layer of TPE-E is chosen in combination with teeth made of PBT. According to a further aspect of the invention, a fluid barrier layer of TPE-U is chosen in combination with either a blend of ABS and PA or a blend of PBT and polycarbonate PC.

According to another preferred aspect of the invention, the tapes of the slide fastener further comprise an adhesive layer between the inner textile layer and the outer fluid-barrier material layer. Advantageously, the adhesive can be selected so as to have a strong physico-chemical affinity for both the materials to be joined. Preferably, the adhesive comprises a polyurethane resin.

The present invention further relates to a process for manufacturing slide fasteners according to independent claim 9.

Preferably, the textile strips are covered by extrusion or by lamination of a selected fluid-barrier material onto the strips of textile material. According to still another aspect of the invention, said fluid-barrier material is in a melted state, so that the surface irregularities of the textile spun yarn of cut fibers remain embedded in the fluid-barrier layer.

Preferably, the teeth are obtained by injection overmolding of the selected thermoplastic material onto said longitudinal edge of each coated strip.

Preferably, the process of the invention further comprises the step of sealing each tape at its short cut edge(s) with fluid-barrier material. This may be carried out for instance while heat cutting said coated strips or by covering said short cut edge(s) with “fresh” fluid-barrier material.

According to another aspect of the invention, the process further comprises the step of applying an adhesive layer onto the opposite surfaces of each textile strip prior to covering said strips with the fluid-barrier material. The adhesive layer is preferably applied by soaking each textile material strip in a dispersion of a selected adhesive in an organic solvent or by spraying surfaces of each textile material strip with said adhesive dispersion.

The adhesive is then activated during the covering step of the textile material strips with a fluid-barrier material layer, which is performed for instance by extrusion.

Another aspect of the invention is a semi-finished product for making a slide fastener, said product being a coated textile strip as defined above.

The slide fastener of the invention is suitable to manufacture of sports and outdoor activity items such as diving suits, sailing suits, camping tents and the like.

Advantages of the invention are discussed below.

The textile material of the inner layer surface, according to the main feature of the invention, has an irregular, rough surface due to the use of cut fibers. More in detail, the ends of the cut fibers may protrude from the ideal diameter of the yarn, or the same fibers may form loops protruding from said diameter. This results in an irregular, non-smooth surface of the yarn, similar to natural-fiber yarns, while on the contrary common artificial or synthetic fibers yarns have a smooth surface.

As known in the art, natural textile materials such as cotton have short fibers, each fiber typically having a length of a few centimeters, while artificial or synthetic fibers are available with continuous fibers. According to the invention, cut fibers of selected artificial or synthetic textile material are used for the textile material of the inner layer, said fibers being obtained preferably by a cutting process, to imitate the surface of natural yarns.

It has been surprisingly found that a fastener with such inner textile layer has improved resistance to delamination compared to conventional fasteners. It is considered that such improved performance is due to the irregular, rough surface of the yarn, giving a stronger coupling with the fluid-barrier layer. More in particular, it has been found that ends or loops of the fibers, protruding from the ideal diameter of the yarn, remain embedded in the thermoplastic elastomer material of the fluid-barrier layer enhancing the resistance to delamination.

Referring to one of preferred embodiments, wherein the fluid-barrier material is coupled to the textile layer in a melted state, irregularities of the surface remain trapped and embedded in the melted material of the fluid-barrier layer, thus yielding stronger coupling between the layers and improved resistance to delamination.

Further advantages are obtained with the preferred materials as disclosed in dependent claims.

It has been found that slide fasteners manufactured by using the selected materials have surprisingly good mechanical properties at both the interface between the layers of the tapes and the chemical bonding between the fluid barrier layer and the teeth.

In particular, it has been found that by using the selected materials for the inner textile material layer and the outer fluid barrier material layer of the tapes, the layers are capable of reaching optimal values of adhesion to each other that are sufficient for withstanding the normal transfer of traction and shear forces through the contact interface which the slide fasteners are subjected to during their repeated use. At the same time, the thermoplastic elastomer material constituting the outer layer of the tapes confers a good flexibility to the tapes and exhibits a good adhesion by chemical bonding with the thermoplastic material constituting the teeth.

Without wishing to be bound by theory, it is thought that this improved adhesion between the selected materials of this invention is given by their physico-chemical affinity, as well as by the creation of strong chemical bonds at the surface of the materials to be joined in the operating conditions normally used for the manufacture of the tapes by extrusion and for the bonding between the tapes and the teeth by injection overmolding.

Further advantages and characteristics of the slide fasteners according to the inventions will be more evident from the detailed description and examples provided here below, given as indicative and not limiting purpose.

### BRIEF DESCRIPTION OF THE DRAWINGS

FIG. 1 is a schematic view of a fluid-tight slide fastener according to an embodiment of the present invention.

FIG. 2 is an enlarged perspective view of a detail of the slide fastener of FIG. 1 showing the layers of the tape.

FIG. 3 is an enlarged perspective view of a detail of a slide fastener showing the layers of the tape, according to a further embodiment of the present invention.

### DETAILED DESCRIPTION OF PREFERRED EMBODIMENTS

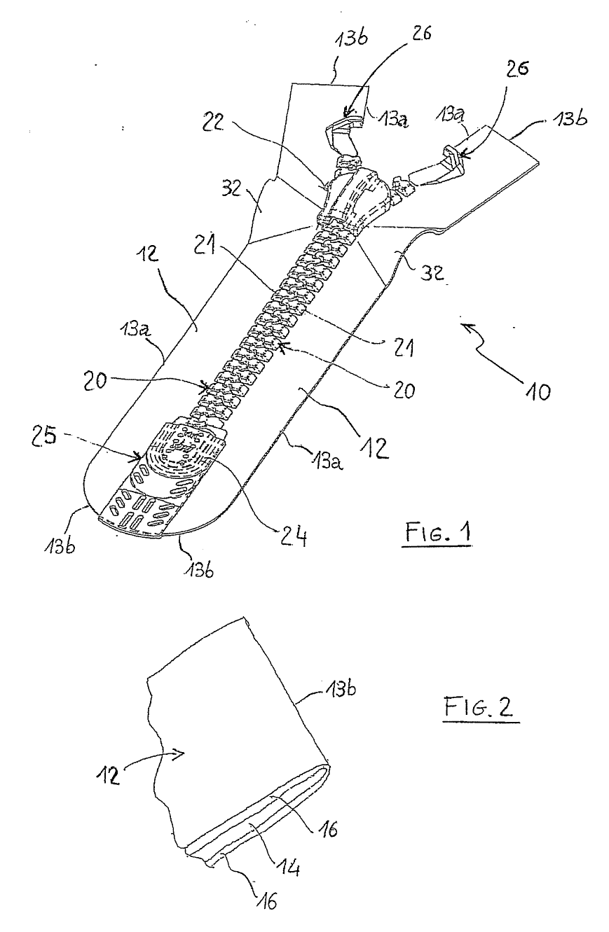

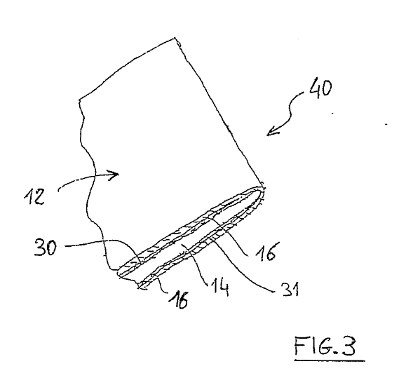

With reference to FIGS. 1 and 2, a fluid-tight slide fastener 10 is shown, in accordance with an embodiment of the present invention.

The slide fastener 10 comprises a pair of tapes 12, substantially parallel to each other, each tape 12 having a side portion, namely a portion of an edge 13a, equipped with a row 20 of aligned teeth 21. Said teeth 21 are realized in a conventional manner, for example through injection overmolding processes.

Rows 20 of aligned teeth 21 face each other and are associated to two stops, namely a bottom stop 24 and a top stop 26, positioned at a predetermined distance from each other along said row of aligned teeth. A slider 22 can engage and disengage teeth 21.

In the FIGS. 1 and 2, the bottom stop 24 is in form of a single piece applied on both the tapes 12 at the lower ends of the rows 20, whereas the top stop 26 comprises two half-portions, each half-portion being applied on a respective tape 12 at the upper end of the respective teeth row 20.

Top stop 24 and bottom stop 26 are fixed to the tapes 12 in a per se conventional manner, for example through injection molding.

Furthermore, the tapes 12 are joined in a fluid-tight way along a portion 25 of the respective inner long edges from the rows 20 of aligned teeth 21 and comprising the bottom stop 24. In particular, with reference to FIG. 1, on the external side of the slide fastener 10 (the external side being the side that is exposed to fluids during use) the portion 25 extends from the bottom ends of said rows 20 of aligned teeth 21 up to bottom short edges 13b of the tapes.

As shown in FIG. 2, each tape 12 comprises an inner reinforcing textile layer 14 enveloped in an outer fluid barrier layer 16. The tape 12 is formed by either extrusion techniques or lamination and the fluid barrier layer 16 entirely covers the inner textile layer 14 so that no part of said textile layer 14 remains exposed.

Textile layer 14 gives the tape 12 a certain degree of pliability. It is important, in fact, that the slide fastener can be bent and adapted to the shape of the item onto which it is applied without it cracking, snapping or otherwise getting damaged or generating an encumbrance to said item.

Textile layer 14 is made with a spun yarn of cut fibers of an artificial or synthetic textile material. The yarn has an irregular, rough natural-like external surface, due to the use of cut fibers.

In accordance with preferred embodiments of the invention, said textile layer 14 is made of fibers of PE, preferably PET, PA or their blends or copolymers and said fluid barrier layer 16 is made of a thermoplastic elastomer material chosen between TPE-E and TPE-U.

Furthermore, said fluid barrier layer 16 is fully compatible with the material of textile layer 14 so that, upon manufacture by extrusion or lamination, the two layers undergo an interaction which brings about a strong and solid adhesion between them.

Teeth 21 are preferably made of a thermoplastic material chosen among polybutylene terephthalate (PBT), acrylonitrile butadiene styrene (ABS), polyamide (PA) and their blends or copolymers.

In this way, the material of the aligned teeth 21 is fully compatible with the material of fluid barrier layer 16, so as to form a fluid-tight seal upon application of a set 20 of aligned teeth 21 on an edge of said tape 12 for example through overmolding processes.

FIG. 3 shows a detail of a slide fastener, globally indicated with 40, according to a further embodiment of the present invention. In this figure, features of the slide fastener 40 structurally or functionally equivalent to those of the slide fastener 10 of FIGS. 1 and 2 are denoted with the same reference number.

Each tape 12 of slide fastener 40 comprises an inner reinforcing textile layer 14 enveloped in an outer fluid barrier layer 16 which entirely covers the inner textile material layer 14 so that no part of the inner textile material 14 remains exposed. Further to this, tapes 12 of fastener 40 also includes adhesive layers 30, 31 applied on opposite top and bottom surfaces of the textile layer 14.

In the areas where the adhesive layer is present, the textile layer 14 and the fluid-barrier layer 16 are then joined indirectly by a strong chemical bonding between the adhesive molecules and the materials constituting the textile layer 14 and the fluid-barrier layer 16, which further increase the resistance to delamination of layers 14 and 16.

The followings are non-limiting examples for the manufacture of slide fasteners according to the invention.

### Example 1

A yarn was produced by a conventional spinning method, with polyester fibers which have been previously cut to obtain natural-like short fibers. The yarn so obtained had an irregular, rough surface, similar e.g. to a “pile” textile material, which imitates a natural-fiber yarn.

Said yarn was used for making textile strips, which were fully coated with a layer of melted TPE-U by means of a conventional extrusion head.

The coated strips were then equipped each with a plurality of rows of aligned teeth along a longitudinal edge, said rows being set at a predetermined distance to each other. The teeth were each made from a blend of ABS and PA. The teeth application was performed by injection overmolding the teeth material onto said longitudinal edge of the coated strips in a conventional way (according to the procedure suggested by the manufacturer).

The coated strips equipped with said rows of aligned teeth were then heat-cut transversally along consecutive rows of aligned teeth to obtain a plurality of tapes of the same dimensions, wherein each tape was equipped with a row of aligned teeth.

Short edge(s) of the tapes remained uncoated due to the heat-cut, and were sealed with fluid barrier material.

A plurality of slide fasteners according to invention was then obtained each from a pair of such tapes through a succession of further conventional steps among which the steps of equipping each pair of tapes with top and bottom stops and a slider running between said stops.

The slide fasteners so obtained were tested for their resistance to delamination of the layered structure of the tapes. Each test sample was engraved on its surface so as to peel (raise) a small rectangular portion (about 15×40 mm) of the said fluid-barrier layer from the respective tape. Then, the small rectangular portion of the fluid-barrier layer and a free end portion of the tape (in the direction opposite to that of peeling) were clamped in two opposite flat clamps of a dynamometer respectively and the sample was put perpendicularly to the flat clamps.

Afterwards, a clamp was moved away from the other clamp at a constant rate so subjecting the sample to traction with increasing load. Minimum load (in kg) necessary to obtain delamination (delamination load) was measured.

An average delamination load of 1.8 kg was measured. In comparison, conventional slide fasteners, with a conventional inner textile layer, were found to have a delamination load of 1.3 to 1.6 kg.

The above results prove that the invention achieves a very good bonding between the inner textile material and the outer fluid-barrier material. As a consequence, the slide fasteners according to the invention are able to retain their fluid-tight characteristics after long-term use and upon repeated exposure to tensile stresses deriving for instance from their frequent and repeated use and upon conventional washing operations.

With regard to the teeth, the slide fasteners of the invention also exhibit good mechanical properties at the interface with the tapes which are fully comparable to those of conventional slide fasteners, thereby proving that the present invention also achieves a good chemical bonding between the teeth material and the outer fluid-barrier material of the tapes.

### Example 2

Slide fasteners were prepared by using an adhesive for bonding the layers of the tapes.

An adhesive layer (polyurethane resin) was applied on the opposite surfaces of strips of PE, by soaking the strips in an adhesive dispersion; the strips were then covered with a TPE-U fluid-barrier layer according to the procedure of example 1.

The same procedure of example 1 was also followed after coating the strips, thereby obtaining a plurality of slide fasteners which were tested for their resistance to delamination of the layered structure of the tapes.

It was found that, thanks to the presence of adhesive in-between, the fluid-barrier layer and the textile layer of the respective tape were bonded extremely strong to each other and as a result no delamination of such layers was observed both before and after each of repeated washing cycles.

In particular, in any case, the fluid-barrier layer and the textile layer of the respective tape were found to be so strongly bonded to each other that it was not possible to raise any portion of the fluid-barrier layer for performing the tests in accordance with the procedure of example 1.

Again, the mechanical properties of the teeth have been found to be fully comparable with those of the prior art slide fastener teeth, thereby proving that in the manufacturing example according to the invention a good chemical bonding between the teeth material and the outer fluid-barrier material of the tapes has been achieved as well.

From the previous description it can clearly be seen that the fluid-tight slide fastener according to the present invention solves the technical problem, mostly by the fact that it exhibits good long-term fluid-tight characteristics and resistance to delamination.

Furthermore, the slide fastener of the invention features many advantageous characteristics, including: good flexibility, low brittle temperature (about −40° C.), performance stability in air at −30 to +70° C., ease of coloring, water resistance (low hygroscopicity), resistance to sea water, and chemicals such as petrol or ammonia, visible and UV light stability, ease of sealing, gluing and stitching.

Of course, a person skilled in the art can bring numerous modifications and variants to the fluid-tight slide fastener described above in order to satisfy specific and contingent requirements, all of which are in any case covered by the scope of protection of the present invention, as defined by the following claims.

1. A fluid-tight slide fastener comprising:
a pair of tapes, each of said tapes comprising an inner textile layer and a fluid barrier layer enveloping said textile layer; and
a plurality of engaging teeth elements provided on a side portion of said tapes;
wherein said inner textile layer of tapes is made with a spun yarn of cut fibers.

2. The slide fastener according to claim 1, wherein said spun yarn is obtained with a cutting process of continuous fibers, said yarn having an irregular, rough external surface with irregularities embedded in said fluid barrier layer.

3. The slide fastener according to claim 1, wherein:
said textile layer is made of a textile material chosen among polyester (PE), preferably polyethylene terephthalate (PET), polyamide (PA) and their blends or copolymers;
said fluid barrier layer is made of a thermoplastic elastomer material (TPE) chosen between thermoplastic elastomer polyurethane (TPE-U) and thermoplastic elastomer polyester (TPE-E); and
said teeth are made of a thermoplastic material chosen among PBT, ABS, polyamide (PA) and their blends or copolymers.

4. The slide fastener according to claim 3, wherein said fluid-barrier layer is made of a material chosen between polyether-ester block copolymer and a block copolymer obtained from an ether and/or an ester and an isocyanate.

5. The slide fastener according to claim 1, wherein said teeth elements are made of a thermoplastic material blend including PBT and polycarbonate (PC) with PBT to PC weight ratio ranging between 70:30 and 30:70.

6. The slide fastener according to claim 1, wherein said teeth elements are made of a thermoplastic material blend including acrylonitrile butadiene styrene (ABS) and a polyamide (PA), said blend having an ABS to PA weight ratio ranging between 70:30 and 30:70.

7. The slide fastener according to any claim 1, further comprising an adhesive layer between said inner textile layer and said fluid-barrier layer.

8. The slide fastener according to claim 7, wherein said adhesive layer is made of a polyurethane resin, said resin being dispersed in an organic solvent.

9. A process for manufacturing fluid-tight slide fasteners, said process comprising the steps of:
covering strips of a textile material with a fluid-barrier layer, thus obtaining coated, fluid-proof strips;
providing a plurality of engaging teeth along a longitudinal edge of each of said coated strips;
heat-cutting each coated strip to obtain tapes of a desired length and equipped with a respective set of teeth; and
coupling said tapes in pairs and equipping each pair of tapes with at least a top end stop, a bottom end stop and a slider,
wherein said strips of a textile material are made with a spun yarn of cut fibers, said fibers being obtained with a cutting process of continuous fibers.

10. The process according to claim 9, wherein said strips of textile material are coated by extrusion or lamination of a selected fluid-barrier material onto said textile strips, said fluid-barrier material being in a melted state, so that surface irregularities of said textile material remain embedded in the fluid-barrier layer.

11. The process according to claim 10, wherein said fluid-barrier material is chosen between a thermoplastic elastomer polyurethane (TPE-U) and a thermoplastic elastomer polyester (TPE-E).

12. The process according to claims 9, wherein said teeth are obtained by injection overmolding of the selected thermoplastic material onto said longitudinal edge of each coated strip.

13. The process according to claim 9, further comprising the step of sealing each tape (12) with said fluid-barrier material, at short cut edge(s) defined by said heat-cutting.

14. The process according to claim 9, further comprising the step of applying an adhesive layer onto the opposite surfaces of each strip before covering said strips with said fluid-barrier material.

15. The process according to claim 14, wherein said covering steps is performed by soaking each textile material strip in a dispersion of the selected adhesive in an organic solvent or by spraying said adhesive dispersion onto the opposite surfaces of each textile material strip

16. A sports and outdoor activity item, such as diving suit, sailing suit, camping tent and the like, comprising a fluid-tight slide fastener according to claim 1.
